(19) United States
(12) Patent Application Publication
(10) Pub. No.: US 2020/0236933 A1
(43) Pub. Date: Jul. 30, 2020

(54) USE OF A NON-IONIC SURFACTANT WHICH IS A POLYOL DERIVATIVE AS A PLANT GROWTH STIMULATING AGENT OR AS AN ADJUVANT

(71) Applicant: INNOVI, Layrac (FR)

(72) Inventors: Alexandra FREGONESE, MONCAUT (FR); Marie NAVARRO, MARMONT PACHAS (FR); Alexandre EVEILLARD, MOIRAX (FR)

(21) Appl. No.: 16/636,698

(22) PCT Filed: Aug. 7, 2018
(86) PCT No.: PCT/FR2018/052033

§ 371 Date: Feb. 5, 2020

(30) Foreign Application Priority Data
Aug. 7, 2017 (FR) 1757557

(51) Int. Cl. A01N 43/16

(52) U.S. Cl. CPC A01N 43/16

(57) ABSTRACT

Disclosed is at least one non-ionic surfactant, which is a polyol derivative, as an agent for stimulating plant growth, in particular for germination and/or root growth (including root architecture), as well as to its use as an adjuvant, the polyol derivative being a sugar derivative. The non-ionic surfactant is selected from sugar and fatty acid esters, alkylmonoglucosides, alkylpolylucosides, alkylmonoglucoside and fatty acid esters, alkylpolyglucoside and fatty acid esters, and N-alkylglucamides, in particular, sucrose esters, sorbitan esters, and glucose esters.

The invention concerns the use of at least one polyol derivative non-ionic surfactant as a plant growth stimulating agent, in particular in relation to germination and/or root growth (including root morphology).

The invention also concerns the use of at least one polyol derivative non-ionic surfactant as an adjuvant for a phytosanitary product.

Preferably, said polyol derivative is a sugar derivative.

Chemical control, which is practically generalized, puts pressure on the environment and shows its limits of application with the arising of resistance by pests and pathogens, of pollution and of harmful effects strongly suspected in relation to human health.

The mastery over inputs to farming is primarily an economic issue. Their use must take into account their effectiveness, which reduces when the optimum is approached until it cancels itself, and then leads to the inverse beyond a certain threshold, as well as their cost which cuts the profit margin of the farming in the context of market competition.

Beyond being an economic issue, it is also an environmental issue, some forms of agriculture, such as sustainable agriculture, seeking to save on inputs for all categories. At the same time, organic agriculture, on account of its specification, prohibits chemical inputs without taking into account energy inputs.

The penetration of inputs (i.e. exogenous substances) is limited across plant epitheliums, on account of their structure. This most often leads, in response, to an increased exposure to those substances (greater amount or greater frequency).

The present invention provides a solution to this problem thanks to the use of at least one polyol derivative non-ionic surfactant as a plant growth stimulating agent.

In the context of the present invention, by “plant growth stimulating agent” is meant a compound that has a stimulating activity on the seeds and/or roots of a plant.

This definition concerns specific applications, among which may for example be cited the fact of promoting germination, root elongation, rootlet formation, vertical anchoring of the root or ending dormancy. These applications are quite specific applications able to enter within the general definition of a “biostimulant” or “plant biostimulant” as defined in accordance with the study commissioned by the Center for Studies and Prospects of the Ministry of Agriculture, Agri-food and Forests (MAAF) and financed by the MAAF as part of Program 215 (Contract No. SSP-2013-094, Final report—December 2014) entitled “Products for stimulation in agriculture aimed at improving biological functionalities of soils and plants—Study of the available knowledge and strategic recommendations”, but are distinct therefrom.

A biostimulant is also defined as: “Matter that contains a substance or substances and/or a microorganism or microorganisms whose function when applied to plants or the rhizosphere is to stimulate natural processes to enhance/benefit nutrient uptake, nutrient efficiency, tolerance to abiotic stress, and crop quality, independently of the nutrient content of the biostimulant.” (EBIC, 2014).

It should however be noted that these general definitions of biostimulant encompass the stimulation of properties of resistance to abiotic stresses. Similarly, biocontrol products concern in particular the protection of plants in relation to biotic stresses. It should however be noted that these applications for biotic and/or abiotic stresses fall outside the field of the invention.

The invention thus relates to the use of at least one polyol derivative non-ionic surfactant as a plant growth stimulating agent having activity on the seeds and/or the roots of a plant.

According to a preferred aspect that applies to all the aspects of the invention described below, said polyol derivative is a sugar derivative.

Advantageously, said polyol derivative non-ionic surfactant stimulates or promotes the germination and/or the root growth and/or the vertical anchoring of the roots of a plant.

According to the present description, “the seeds” means one or more seeds, and “the roots” means one or more roots.

By “promote root growth” it is meant that said polyol derivative non-ionic surfactant stimulates or promotes root elongation and/or the formation of rootlets.

Advantageously, it was also found that the application of at least one polyol derivative non-ionic surfactant may enable root elongation, coupled with vertical anchoring of the roots.

Without wishing to be bound by a mechanism of action, the hypothesis may be proposed that this root growth (including the modification of the root morphology) may promote the production of auxine (which is a phytohormone involved in the processes of division, elongation and differentiation in plants) and facilitate its transport into the plant apex, leading to better anchoring of the plant to the ground. The plant can thereby profit from a greater quantity of water and from a greater reserve of nutrients, so improving its growth in addition.

It has also been found that the use of at least one polyol derivative non-ionic surfactant as a plant growth stimulating agent according to the invention, enabled the efficiency of the nutrients to be improved, that is to say the use of the nutrients by the plant.

This use also enables the yield of seed or fruit plants to be improved, the yield being calculated by the ratio of the weight of the seeds or fruit harvested to the sowed surface area.

Actually, these activities of stimulation or improvement may be linked, in particular, to the root growth, and especially to the formation of rootlets and/or the vertical anchoring of the roots (root architecture). These phenomena enable the plant to seek nutrients, and particular minerals, in the deep parts, especially the hard parts, of the ground, and/or to accumulate reserves of nutrients needed for the development of seeds and/or fruit.

Application DE3234610 describes the use of glycerol derivatives as plant growth regulating agents. However, application DE3234610 does not describe a sugar derivative non-ionic surfactant.

Application EP1570735 describes a composition comprising any one of the organic compounds 1), 2) and 3) defined in paragraph [0011], and in particular a glycerol derivative 3), as a plant growth promoting agent. This promoting agent is combined, in particular, with a fertilizer, a surfactant which may be non-ionic (paragraph [0043]) and a chelating agent. As indicated in paragraph [0042], said surfactants are used as an additive in the composition (emulsifier, solubilizing agent, dispersant, etc.) and not as an agent having an activity in relation to the growth of the plant.

Application EP2183959 describes the use of a sugar derivative based surfactant to give plants tolerance to abiotic stress, such as saline or osmotic stress, drought, temperature, or biotic stress tolerance. The examples appearing in that application solely concern abiotic stress tolerance. In the examples, stress tolerance is measured by the comparison of the fresh weight of the untreated plants (control) with that of the treated plants. No measurement is made on the seeds or the root system. Application EP2183959 neither describes nor suggests a stimulating activity specific to a sugar derivative based surfactant in relation to germination and/or root growth and/or the vertical anchoring of the roots.

The polyol derivative non-ionic surfactant is used in a sufficient amount to stimulate or promote the germination and/or the root growth and/or the vertical anchoring of the roots of a plant.

The polyol derivative non-ionic surfactant is, preferably, used in a composition in the form of a single-phase solution, or an emulsion, in particular in the form of a single-phase aqueous solution. Preferably, said polyol derivative non-ionic surfactant is used in a range from approximately 0.01% to approximately 80% by weight of polyol derivative non-ionic surfactant relative to the total weight of the composition, more preferably from approximately 0.05% to approximately 30%, and still more preferably from approximately 0.5% to approximately 3%.

In the context of the present invention, the polyol derivative non-ionic surfactants used as plant growth stimulating agent as defined above or as adjuvant are, as indicated above, preferably sugar derivative non-ionic surfactants, and may in particular be chosen from esters of sugar and fatty acid(s), alkylmonoglucosides, alkylpolyglucosides, esters of alkylmonoglucoside and fatty acid(s), esters of alkylpolyglucoside and fatty acid(s) and N-alkylglucamides.

By “sugar” is meant a mono or polysaccharide, preferably sucrose, sorbitan, or glucose, more preferably sucrose or glucose.

By “fatty acid” is meant a carboxylic acid comprising a saturated or unsaturated hydrocarbon chain in which the number of carbon atoms in the hydrocarbon chain, including the carbon atom of the carboxylic acid function, is comprised between 6 and 26, preferably between 8 and 20, and more preferably between 10 and 18. Advantageously, the fatty acid is chosen from stearic acid, lauric acid, palmitic acid, and oleic acid, preferably lauric acid or stearic acid.

Preferably, the ester of sugar and fatty acid(s) is chosen from sucrose esters, sorbitan esters, and glucose esters, more preferably the ester of sugar and fatty acid(s) is chosen from sorbitan laurate, sucrose palmitate, glucose stearate, and sucrose stearate, still more preferably the ester of sugar and fatty acid(s) is sucrose stearate, also called saccharose stearate.

By an “alkyl” group is meant a linear or branching hydrocarbon chain that is saturated or unsaturated.

By “alkylmonoglucoside” is meant a molecule formed by the reaction of a glucose unit with an alcohol. Preferably, the alkyl group of the alcohol comprises from 6 to 26 carbon atoms, more preferably from 8 to 20 carbon atoms, still more preferably from 10 to 18 carbon atoms. Advantageously, the alkylmonoglucoside is chosen from decylglucoside, laurylglucoside and cetearyl glucoside, preferably the alkylmonoglucoside is decylglucoside.

By “alkylpolyglucoside” is meant a molecule formed by the reaction of several glucose units, linked together by a glycosidic bond, with an alcohol. Preferably, the alkylpolyglucoside consists of 2 to 6 units of glucose, more preferably, of 3 to 5 units of glucose. Preferably, the alkyl group of the alcohol comprises from 6 to 26 carbon atoms, more preferably from 8 to 20 carbon atoms, still more preferably from 10 to 18 carbon atoms.

Esters of alkylglucoside and fatty acid(s) are, for example, methylglucose dioleate or methylglucose sesquistearate.

“N-alkylglucamide” denotes a compound in which the nitrogen atom is substituted by an alkyl group comprising from 1 to 5 carbon atoms, preferably from 1 to 3 carbon atoms, more preferably 1 carbon atom. Furthermore, the amide part of the N-alkylglucamide comprises from 6 to 26 carbon atoms, more preferably from 8 to 20 carbon atoms, still more preferably from 10 to 18 carbon atoms. Advantageously, the N-alkylglucamide is N-lauroyl-N-methylglucamide.

In a particular implementation, the polyol derivative non-ionic surfactant is ethoxylated or is not ethoxylated.

An “ethoxylated polyol derivative surfactant” denotes a polyol derivative surfactant as defined above, the free hydroxyl functions of which have reacted with ethylene oxide leading to groups of the —O (C₂H₄)ₙOH type, n being comprised between 1 and 15, preferably between 3 and 12, more preferably between 5 and 10.

The polyol derivative non-ionic surfactant is used in a sufficient amount to stimulate or promote the germination and/or the root growth, in particular the formation of rootlets, and/or the vertical anchoring of the roots of a plant (root architecture).

Said polyol derivative non-ionic surfactant may be used in combination with nutrients, one or more fertilizers, one or more growth regulators and/or biocontrol products.

For example, the use of the polyol derivative non-ionic surfactant may be supplemented by the use of one or more substances which are aimed at preventing the action of organisms that are harmful to plants (elicitors, fungicides, fungistats, bactericides, bacteriostats, insecticides, acaricides, parasiticides, nematicides, talpicides, repellents for birds or game), simultaneously or sequentially.

Furthermore, the polyol derivative non-ionic surfactant may be used in combination with the use of one or more substances aimed at destroying undesirable plants or at slowing the growth thereof (herbicides, anti-Dicotyledons).

The use of the polyol derivative non-ionic surfactant also makes it possible to promote the absorption of water and/or the retention of water in the leaves, the roots and the integuments, the spreading on the surface of plants (aerial and underground parts) in order to increase the contact surface area, the passage of molecules by the middle lamella or increase the contact time with the active or nutritive substances, or to limit the evaporation of water by the leaves, as described below.

In the context of the present invention, the polyol derivative non-ionic surfactant may used in pre or post emergence, on the seed, the seedling (juvenile stage before flowering), the plant in course of flowering (before, during or after pollination), the plant after fecundation, the plant during fruiting, the fruit, the flowers, the leaves, the stems, the roots or in the soil, and/or the growth medium, before or after sowing.

By “emergence” is meant the coming up of a seedling from the ground.

Preferably, the polyol derivative non-ionic surfactant is applied to the seed.

It is possible to treat plants cultivated in the open field or plants in a greenhouse or plants cultivated out of the ground.

The use of the polyol derivative non-ionic surfactant according to the invention may be made on any type of plant, the plant being chosen from Dicotyledons and Monocotyledons and more particularly from the group comprising cereals and cereal products, plants with roots and tubers, sacchariferous plants), legumes, nut-bearing plants, oleiferous and oleaginous plants, vegetable crop plants, fruit crop plants, aromatic and spice plants, flower crop plants, industrial crop plants for the production of a raw material for its transformation, etc.

Examples of cereals and cereal products are wheat, rapeseed, and maize.

Examples of root and tuber plants are cassava, sweet potato, yam, colocase, macabo, potato, Jerusalem artichoke, crosne, jicama, beet, nasturtium tuberose, carrot, celeriac, tuberous chervil, kohlrabi, stripped conopod, radish, dahlia, ginger, ginseng, tuberous wisteria, helianthus, hoffe, maca, turnip, parsnip, tuberous parsley, yacon, horseradish, rutabaga, salsify, Spanish scolyme, scorzonera, or ulluco.

By “sacchariferous plant” is meant a plant producing sugar; for example sugar beet or sugar cane.

Examples of legumes are lentils, split peas, peas, chickpeas, beans, broad beans, soy, peanuts, clover, carob, licorice, and alfalfa.

Examples of nut-bearing plants are walnut, almond, and hazel.

Examples of oleiferous or oleaginous plants are rape and sunflower.

Examples of vegetable crop plants are tomato and zucchini.

Examples of fruit crop plants are strawberry, cherry and banana.

Examples of aromatic and spice plants are parsley and cinnamon.

Examples of flower crop plants are chrysanthemum, rose, and Buddleja davidii.

Examples of industrial crop plants industrial crop plants for the production of a raw material for its transformation are flax and cotton.

Preferably, the plant is chosen from soy, maize, parsley, strawberry and Buddleja davidii (also called butterfly bush), more preferably, the plant is chosen from maize and parsley.

The present invention also relates to a method for stimulating the germination and/or the root growth, and/or the vertical anchoring of the roots of a plant comprising applying at least one polyol derivative non-ionic surfactant as described above.

All the general and particular aspects described above for the use of a polyol derivative non-ionic surfactant as an agent for stimulating germination and/or root growth, and/or the vertical anchoring of the roots also apply to the stimulating method.

In accordance with the invention, the step of applying the polyol derivative non-ionic surfactant may be carried out after the emergence or before the emergence.

The polyol derivative non-ionic surfactant may be applied by spraying, watering the plant, adding to a growth medium in hydroponics, immersing the seed and/or coating the seed, preferably by immersing the seed.

The invention also concerns the use of at least one polyol derivative non-ionic surfactant as described above, as an adjuvant.

Preferably, said polyol derivative is a sugar derivative.

By “adjuvant” is meant a compound or a preparation with no phytopharmaceutical activity which is added to phytopharmaceutical products in order to strengthen their physical, chemical and/or biological properties.

By phytopharmaceutical or phytosanitary product is meant an active ingredient or a composition comprising one or more active ingredients, which is intended in particular for:
protecting at least one plant against at least one harmful organism or to prevent its action;
acting upon a vital process of a plant, provided it is not a nutritive substance (for example, a growth regulator) and/or;
ensure preservation of a plant.

In non-limiting manner, the active ingredients may either be of natural origin, or arise from chemical synthesis, and may be substances that are mimetic of natural substances, such as pheromones.

The adjuvants are not phytopharmaceutical products, they have not protective action against pests and pathogens like phytophramaceutical products, but they facilitate their role by improving their performance (retention and/or spreading) and may reduce harmful effects such as run-off and drift.

The use of phytosanitary products requires particular preparation according to the manner of treatment, the surface area treated and the crop treated. The prepared solution of phytosanitary product is called phytosanitary mixture. In the present description, “mixture” means a solution of a phytosanitary product or products.

The activity of a compound or of a preparation as an adjuvant requires said compound or preparation to have at least one of the following functions:
Spreading activity: Enables the retention and spreading out of the droplets of the mixture by reducing the surface tension thereof.
Penetrating activity: Promotes the penetration of the phytosanitary product.
Retention activity: Promotes the holding of the droplets of the mixture to the leaf at the moment of impact.
Stickiness: Promotes the holding of the mixture after the impact. Provision of better resistance to washing off and evaporation.
Limitation of drift: the finest droplets (<100 μm) disperse in the atmosphere. The anti-drift adjuvant homogenizes the size of the droplets by limiting the smallest.
Moistening activity: enables the moisture level at the surface of the leaf to be maintained; avoids crystallization of the active ingredient and the evaporation of the mixture.
Defoaming activity: prevents the formation of foam in the tank on preparing the mixture.
Homogenizing activity: Enables hard water to be neutralized, to buffer the pH and/or to stabilize the mixture.
Acidifying activity: Some active ingredients are rapidly degraded in a basic medium (pH>7) so reducing their effectiveness. Acidifiers enable the pH to be maintained between 5 and 7.

It has now been found that the use of at least one polyol derivative non-ionic surfactant enables at least one, and possibly all, of the functions described above to be fulfilled, with which are advantageously associated the following functions:
Increase in the contact time: the availability of the molecules is dependent both on the surface area and on the time. Although the majority of adjuvants improve spreading, few on the other hand associate therewith an increase in the contact time.
Solubilizing activity: promotes the miscibility of substances that are immiscible with each other.
Persistence activity: enables the reactivation of the molecules when exposed again to water.
Bio-compatibility property: does not interfere with the different strains of micro-organisms (bacteria, yeast, fungus).
Spontaneous solubility property: soluble equally in water and in oil.

Advantageously, said polyol derivative non-ionic surfactant has one or more activities chosen from the following:
penetration agent,
drift-limiting agent,
stickiness agent,
defoaming agent,
solubilizing agent,
pH modifying agent,
homogenizing agent,
foliar surface persistence agent,
agent enabling the content of phytosanitary product to be reduced,
   and may be used in the corresponding applications.

According to the invention, the capacity of said polyol derivative non-ionic surfactant to associate several or all these functions, makes it possible simultaneously to reduce effectively and in large proportions the use of phytosanitary products while increasing their level of effectiveness.

The invention thus satisfies an ecological objective while ensuring greater environmental safety, better effectiveness of the active ingredients and modulation of the doses.

The invention also concerns a method of phytopharmaceutical treatment, comprising administering to a plant a polyol derivative non-ionic surfactant as defined above as an adjuvant for a phytopharmaceutical product.

All the general and particular aspects described above for the use of a polyol derivative non-ionic surfactant as a plant growth stimulating agent having an activity on the seeds and/or the roots of a plant also apply in the context of its use an adjuvant.

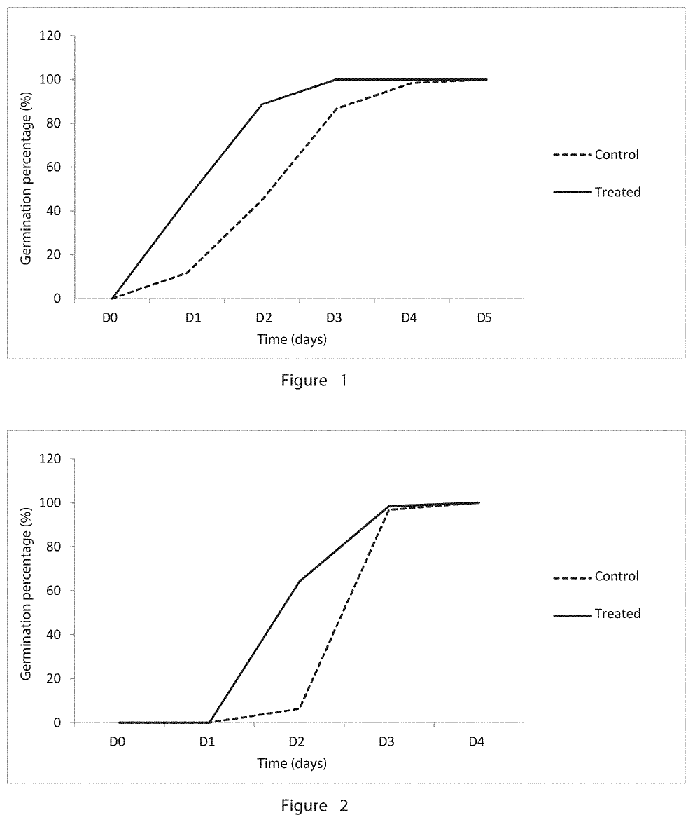

The present invention is illustrated in non-limiting manner by the following examples, as well as by FIGS. 1 to 31;

FIG. 1: Effect of sucrose stearate on the germination of soybeans: percentage of germinated beans treated or not treated (control) as a function of time (days).

FIG. 2: Effect of sucrose stearate on the germination of maize seeds: percentage of germinated seeds treated or not treated (control) as a function of time (days).

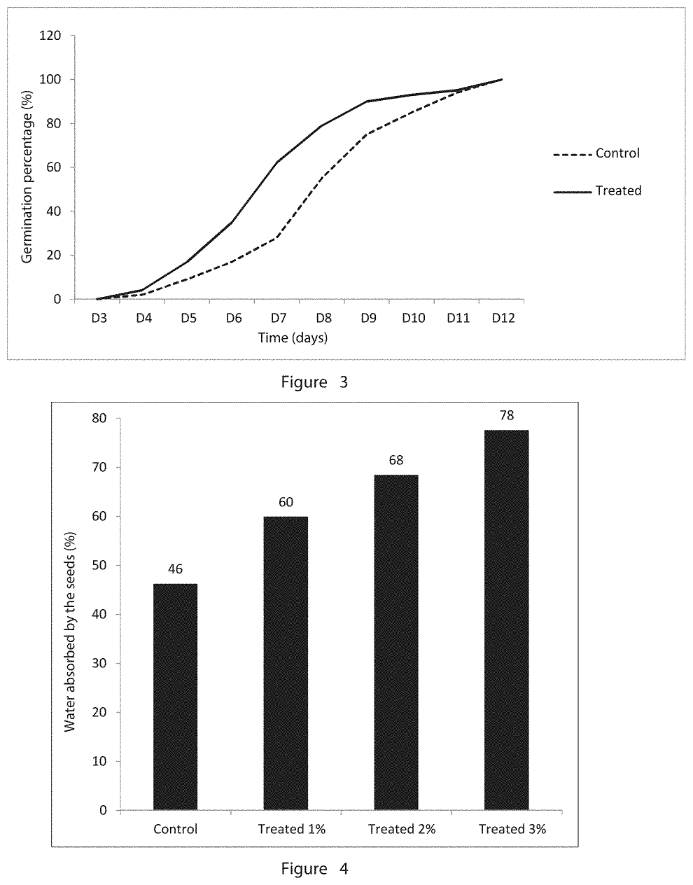

FIG. 3: Effect of sucrose stearate on the germination of parsley seeds: percentage of germinated seeds treated or not treated (control) as a function of time (days).

FIG. 4: Effect of sucrose stearate on the capacity of parsley seeds to absorb water. Percentage of water absorbed as a function of the sucrose stearate concentration compared with untreated seeds (control).

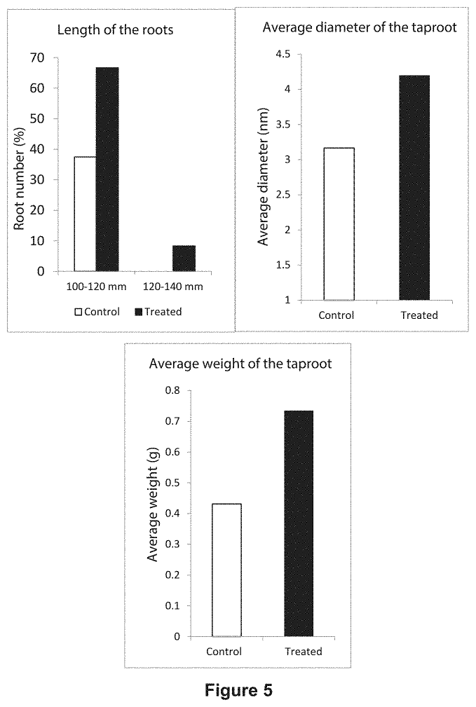

FIG. 5: Effect of sucrose stearate on the root growth of parsley: on the left the percentage of roots of a size comprised between 100 and 120 mm and between 120 and 140 mm is measured in comparison to that of the untreated plants (control), on the right the average diameter of the taproot is measured in comparison to that of the untreated plants (control), at the bottom the average weight of the taproot is measured in comparison to that of the untreated plants (control).

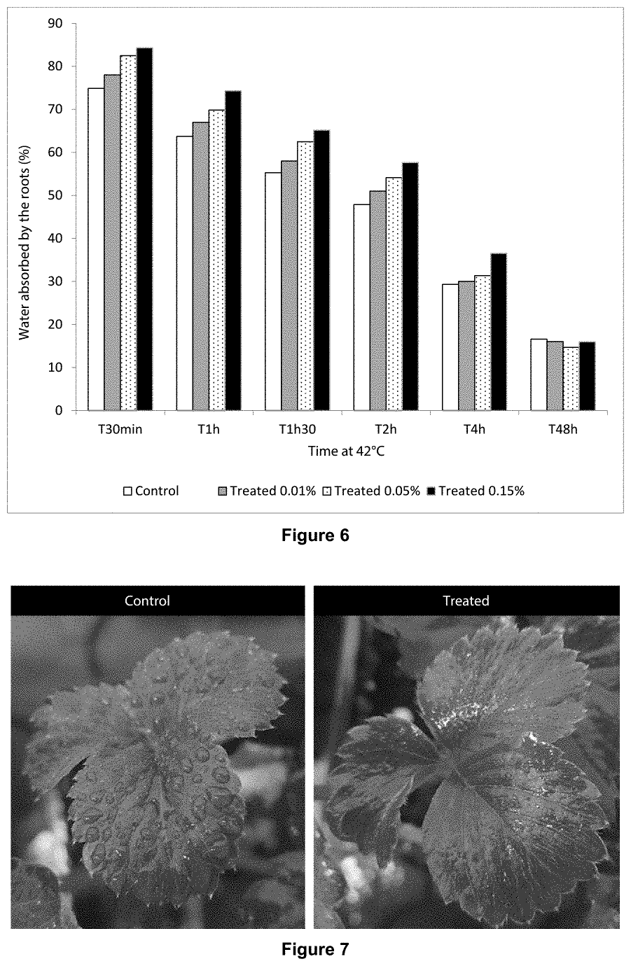

FIG. 6: Effect of sucrose stearate on the capacity of parsley roots to absorb water. Two days after watering, the roots are taken, weighed then placed at 42° C. After 30 min, 1 h 30, 2 h, 4 h and 48 h, the weight of the roots is noted and the amount of water retained is calculated as a percentage of the initial weight.

FIG. 7: Effect of sucrose stearate on the spreading of an aqueous solution on a leaf: the number and the size of the drops on the upper surface of the leaf are compared after spraying with water (control) or a solution comprising 0.75% sucrose stearate.

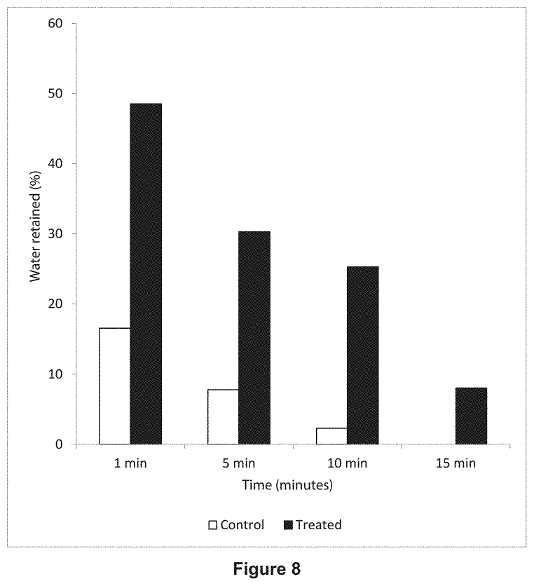

FIG. 8: Effect of sucrose stearate on the evaporation of water at the surface of the leaves. The weight of the leaf is noted prior to the treatment, 1 min after, then every 5 min. The percentage of water retained is calculated relative to the initial weight on leaves treated with 3% sucrose stearate or water (control).

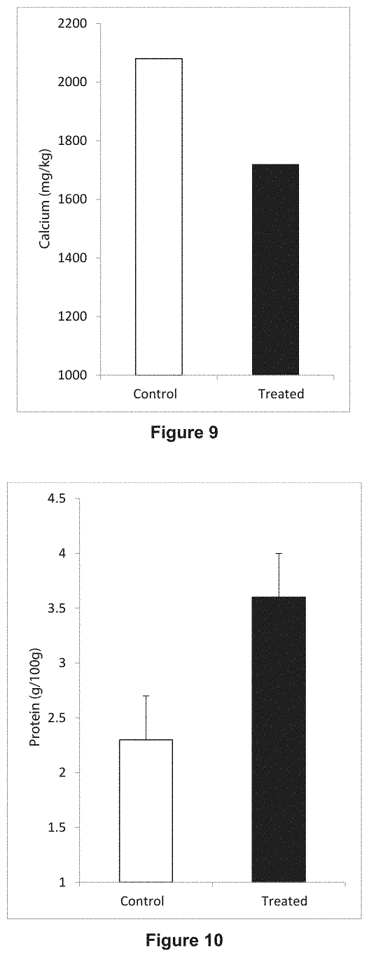

FIG. 9: Effect of sucrose stearate on the calcium content of the leaves. After seven days treatment with a solution of water (control) or of 3% sucrose stearate, the leaves are harvested and analyzed to determine their calcium content.

FIG. 10: Effect of sucrose stearate on the protein content of parsley. After 23 days treatment with a solution of water (control) or of 0.75% sucrose stearate the leaves are cut and an analysis of the amount of protein is carried out.

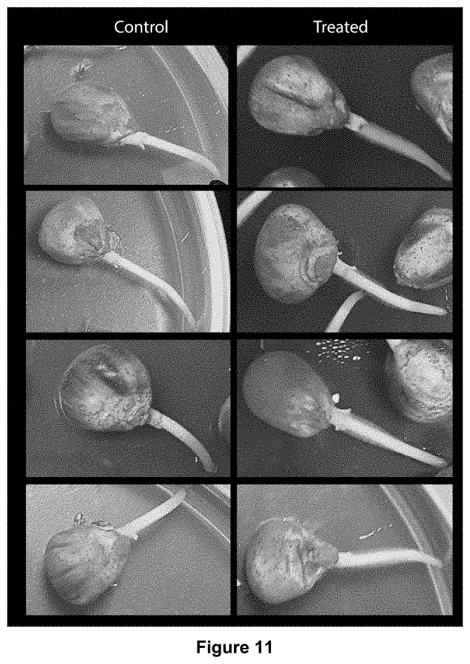

FIG. 11: Effect of sucrose stearate on the root growth of maize seeds: comparison of untreated seeds (control) with treated seeds after two days.

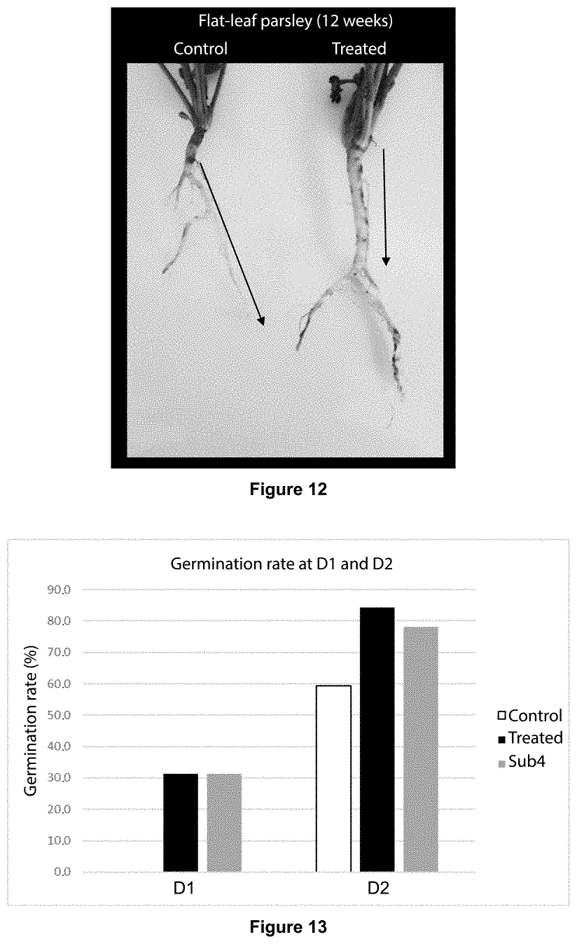

FIG. 12: Effect of sucrose stearate on the vertical anchoring of the roots of parsley seeds (assays in fields): comparison of untreated seeds (control) with treated seeds after twelve weeks.

FIG. 13: Effect of sucrose stearate (treated batch) and of sorbitane laurate (batch Sub4) on the germination of maize seeds: percentage of treated germinated seeds (treated batch and Sub4) or untreated (control) after one and two days.

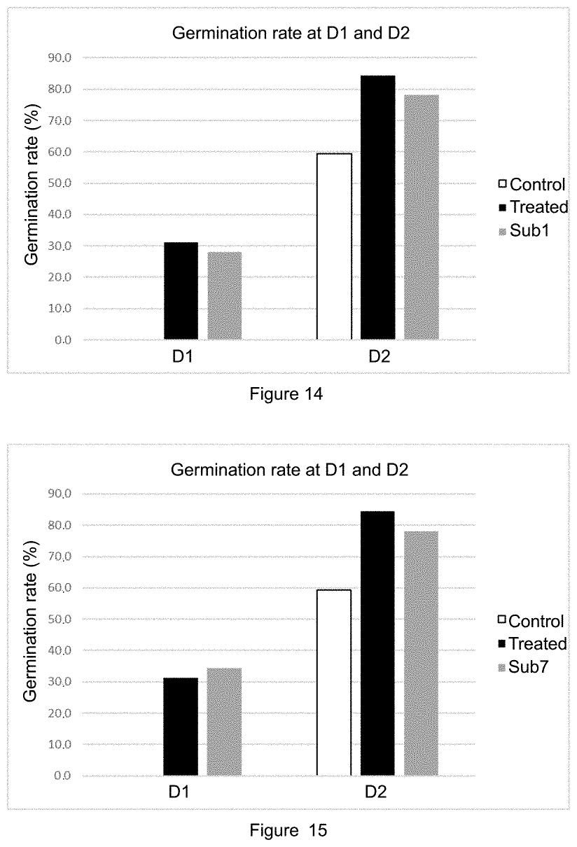

FIG. 14: Effect of sucrose stearate (treated batch) and of sucrose palmitate (batch Sub1) on the germination of maize seeds: percentage of treated germinated seeds (treated batch and Sub1) or untreated (control) after one and two days.

FIG. 15: Effect of sucrose stearate (treated batch) and of glucose stearate (batch Sub7) on the germination of maize seeds: percentage of treated germinated seeds (treated batch and Sub7) or untreated (control) after one and two days.

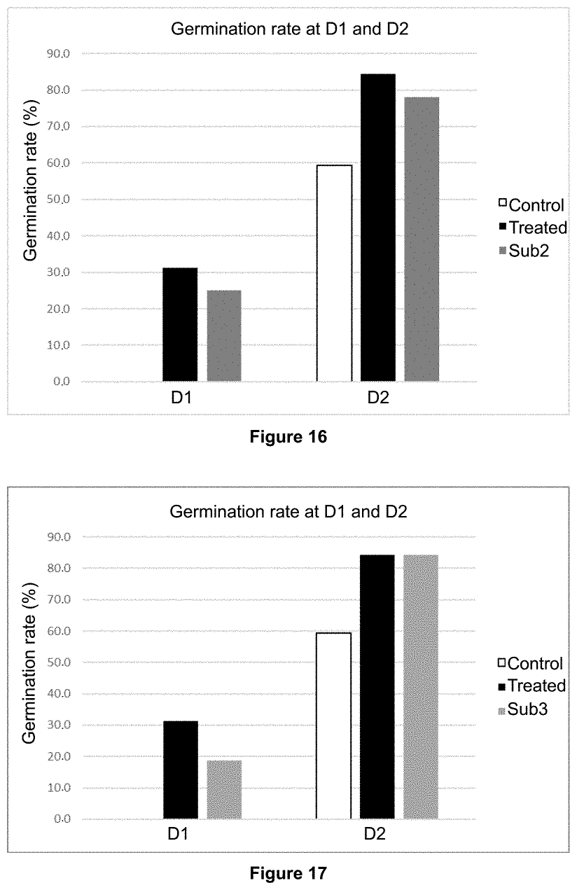

FIG. 16: Effect of sucrose stearate (treated batch) and of polyethoxylated sorbitan laurate (batch Sub2) on the germination of maize seeds: percentage of treated germinated seeds (treated batch and Sub2) or untreated (control) after one and two days.

FIG. 17: Effect of sucrose stearate (treated batch) and of decyl glucoside (batch Sub3) on the germination of maize seeds: percentage of treated germinated seeds (treated batch and Sub3) or untreated (control) after one and two days.

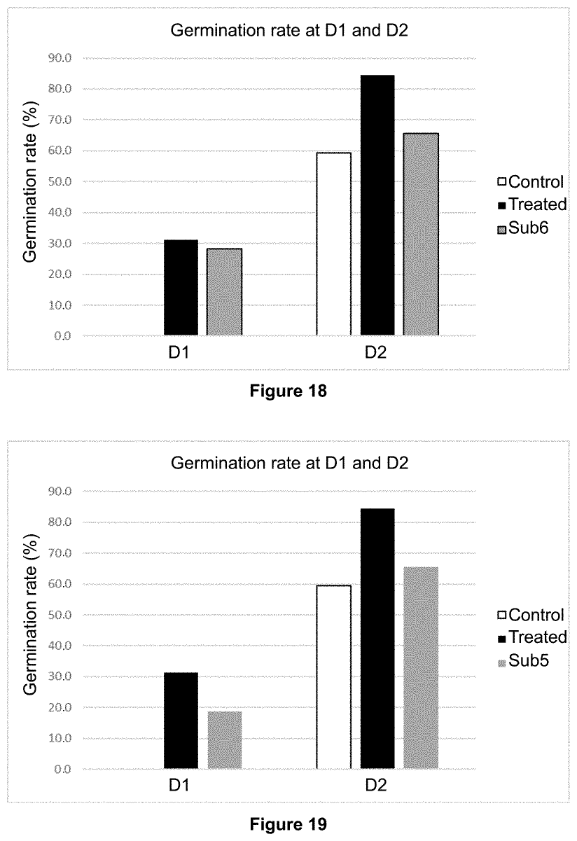

FIG. 18: Effect of sucrose stearate (treated batch) and of N-lauroyl-N-méthyl-glucamide (batch Sub6) on the germination of maize seeds: percentage of treated germinated seeds (treated batch and Sub6) or untreated (control) after one and two days.

FIG. 19: Effect of sucrose stearate (treated batch) and of methylglucose dioleate (batch Sub5) on the germination of maize seeds: percentage of treated germinated seeds (treated batch and Sub5) or untreated (control) after one and two days.

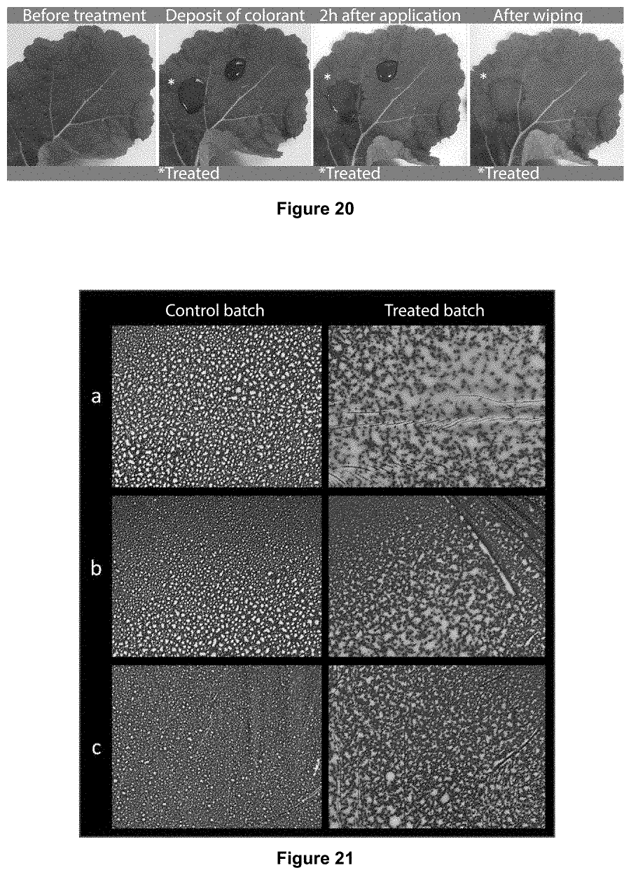

FIG. 20: Effect of sucrose stearate on the penetration of a colored aqueous solution: comparison of the steps prior to treatment, when the treatment is deposited, after 2 h of application and after wiping.

FIG. 21: Effect of sucrose stearate on the limitation of drift: comparison of the size of the droplets further to spraying with an aqueous solution comprising sucrose stearate (treated batch) and an aqueous solution not comprising any (control batch), as a function of different increasing pressures applied (a, b and c).

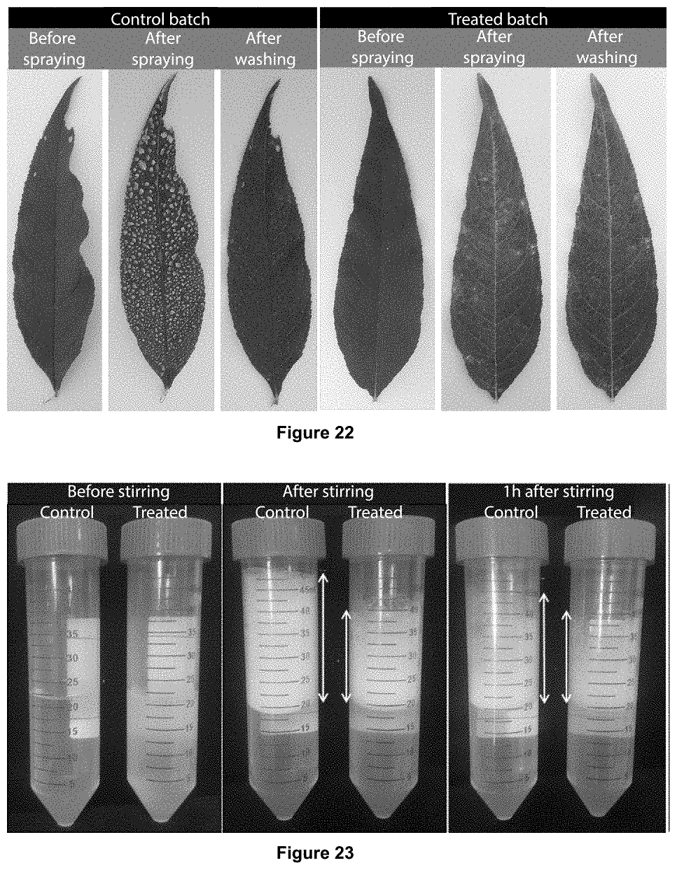

FIG. 22: Effect of sucrose stearate on the stickiness of a solution to a leaf: comparison of untreated leaves (control batch) with treated leaves before and after spraying of the solution, then after washing.

FIG. 23: Effect of sucrose stearate on foaming: comparison of a control solution with a solution treated prior to stirring, immediately after stirring, and 1 h after stirring.

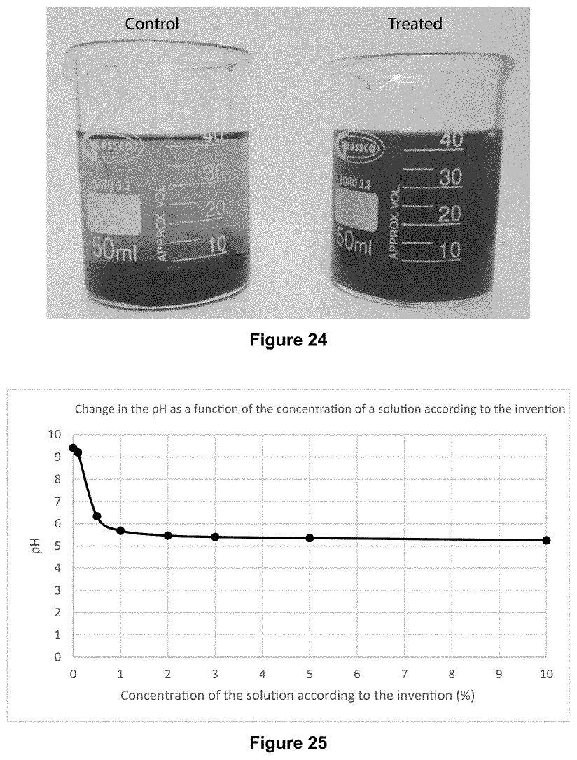

FIG. 24: Effect of sucrose stearate on solubilization: comparison of a control solution with a treated solution.

FIG. 25: Effect of sucrose stearate on modification of the pH: pH as a function of the concentration of a solution according to the invention comprising 2.5% sucrose stearate.

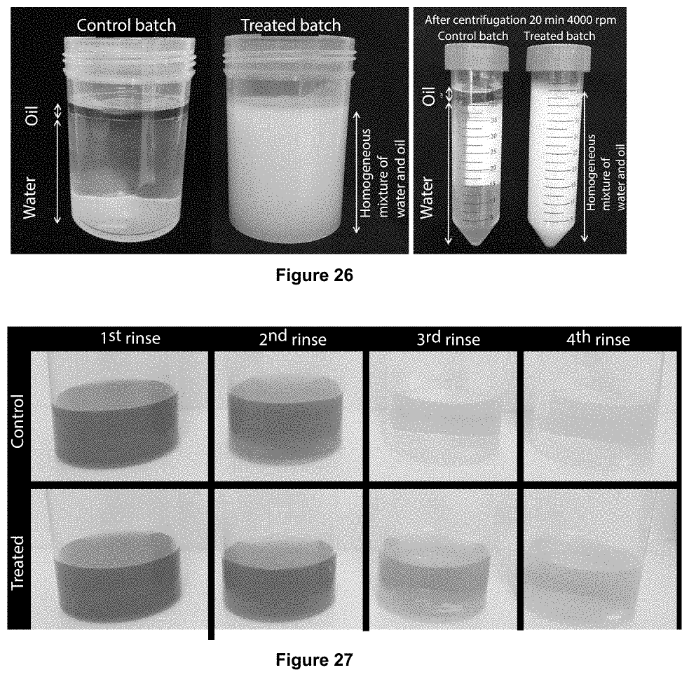

FIG. 26: Effect of sucrose stearate on homogenization: comparison of a control mixture with a mixture comprising sucrose stearate (treated batch). On the left: after a stay in the oven (45° C.) for 24 h, on the right: after centrifugation for 20 minutes at 4000 rpm.

FIG. 27: Effect of sucrose stearate on persistence: comparison of the coloration of the rinse water obtained after 1, 2, 3 and 4 rinses for a control solution and for a solution comprising sucrose stearate (treated).

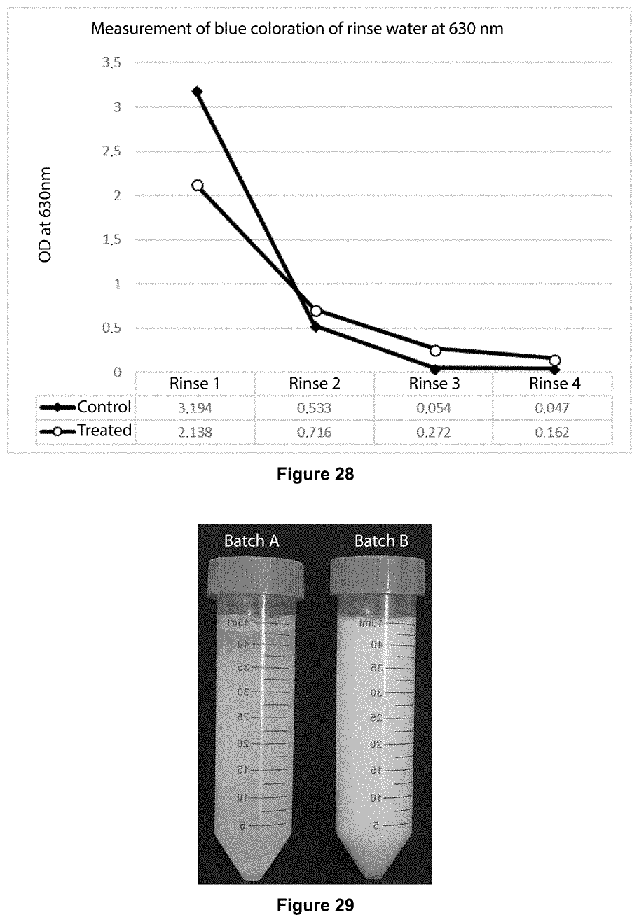

FIG. 28: Effect of sucrose stearate on persistence: measurement of the rinse water coloration at 630 nm (OD) as a function of the number of rinses for the control batch and for the treated batch.

FIG. 29: Solubility of sucrose stearate in water (Batch A) or in oil (Batch B) after centrifugation for 5 min at 4000 rpm.

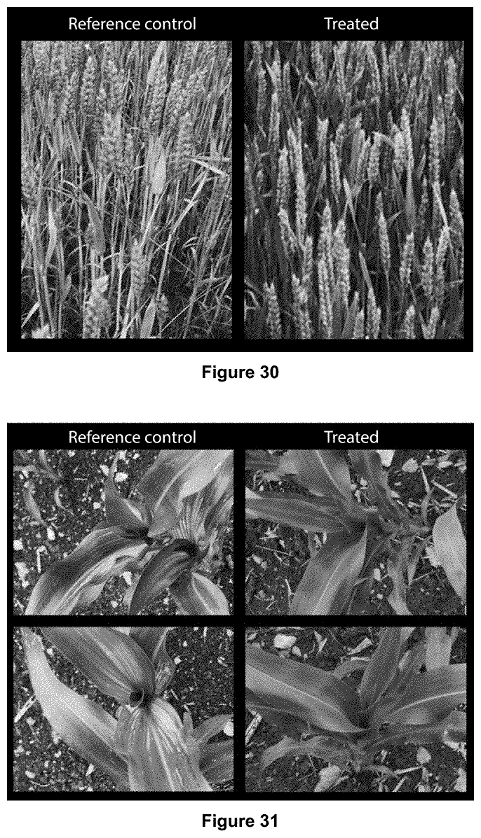

FIG. 30: Effect of sucrose stearate on the reduction in the concentration of phytosanitary products on wheat: comparison at the start of coming into ear of a batch without sucrose stearate (control) with a batch comprising it (treated).

FIG. 31: Effect of sucrose stearate on the reduction in the concentration of phytosanitary products on maize: comparison at the stage of 12-14 leaves of a batch without sucrose stearate (control) with a batch comprising it (treated).

### MATERIAL USED

The origin of the different products used in the examples below is summarized in the following table 1:

TABLE 1

| Material | Supplier |
|---|---|
| Sucrose stearate | SISTERNA |
| Sorbitan laurate | ESCUDER |
| Sucrose palmitate | SISTERNA |
| Glucose stearate | EVONIK |
| Polyethoxylated sorbitan laurate | ESCUDER |
| Decyl glucoside | ESCUDER |
| N-lauroyl-N-methyl glucamide | CLARIANT |
| Methylglucose dioleate | LUBRIZOL |
| Maize seeds | SYNGENTA |
| Barley seeds | ARVALIS |
| Parsley seeds | VILMORIN |
| Soybeans | SYNGENTA |

Unless specified otherwise, percentages are given by weight.

### Example 1: Use of a Sugar Ester as a Germination Stimulating Substance for Soybeans

The sugar ester used is sucrose stearate.

The treatment of the soybeans consists of immersing them 1 h in a solution comprising water alone (control batch) or in a solution composed of 99.25% water and 0.75% sucrose stearate (treated batch). The beans are next dried in a heating tunnel at 45° C. for one hour. Four batch repetitions of 15 beans are deposited on Petri dishes containing a medium composed of 2% Agar Agar and 98% water.

The Petri dishes are kept at ambient temperature and in darkness. Each day the number of germinated beans (having a radicle) is counted.

The results are presented in FIG. 1. After 1 day 4 times more germinated seeds are observed for the treated batch compared with the control batch. The application of sucrose stearate by immersion of the soybeans increases the germination kinetics on average by 25%.

### Example 2: Use of a Sugar Ester as a Germination Stimulating Substance for Maize Seeds

The sugar ester used is sucrose stearate.

The treatment of the maize seeds consists of immersing them 1 h in a solution comprising water alone (control batch) or in a solution composed of 99.25% water and 0.75% sucrose stearate (treated batch). The seeds are next dried in a heating tunnel at 45° C. for one hour. Four batch repetitions of 16 seeds are deposited on Petri dishes containing a medium composed of 2% Agar Agar and 98% water.

The Petri dishes are kept at ambient temperature and in darkness. Each day the number of seeds that have germinated (having a radicle) is counted.

The results are presented in FIG. 2.

After 2 days 10 times more germinated seeds are observed for the treated batch compared with the control batch. The application of sucrose stearate by immersion of the maize seeds increases the germination kinetics on average by 30%.

### Example 3: Use of a Sugar Ester as a Germination Stimulating Substance for Parsley Seeds

The sugar ester used is sucrose stearate.

The treatment of the parsley seeds consists of immersing them 1 h in a solution comprising water alone (control batch) or in a solution composed of 99.25% water and 0.75% sucrose stearate (treated batch). The seeds are next dried in a heating tunnel at 45° C. for one hour. Two batch repetitions of 48 seeds are deposited on Petri dishes containing a medium composed of 2% Agar Agar and 98% water.

The Petri dishes are kept at ambient temperature and in darkness. Each day the number of seeds that have germinated (having a radicle) is counted.

The results are presented in FIG. 3.

Between 4 days and 6 days 2 times more germinated seeds are observed for the treated batch compared with the control batch. The application of sucrose stearate by immersion of the parsley seeds increases the germination kinetics on average by 10%.

### Example 4: Effect of a Sugar Ester on the Capacity of the Seeds to Absorb Water

The sugar ester used is sucrose stearate.

The treatment of parsley seeds consists of immersing 1 g of parsley seeds in:
25 milliliters of a solution comprising water alone (control batch),
25 milliliters of a solution composed of 99% water and 1% sucrose stearate (treated batch 1%).
25 milliliters of a solution composed of 98% water and 2% sucrose stearate (treated batch 2%).
25 milliliters of a solution composed of 97% water and 3% sucrose stearate (treated batch 3%).

After 1 hour of immersion, the solution is filtered on cloth, the seeds are collected and placed on absorbent paper for 1 min and then weighed.

The amount of water absorbed by the seeds is calculated as a percentage relative to the initial dry weight.

The results are presented in FIG. 4.

The amount of water absorbed increases linearly with the amount of sucrose stearate applied in the treatment (1 and 3%) with variations in water content ranging from +30% to +70%. The use of sucrose stearate facilitates the absorption of water by the seed.

### Example 5: Effect of a Sugar Ester on Root Growth (Assays in Fields)

The sugar ester used is sucrose stearate.

In order to test the effect of the invention in conditions of crops in fields, the flat-leaf parsley variety NOVAS (Petroselinum crispum var. neapolitanum) is used.

The treatment consists of immersion for 1 h of the NOVAS parsley seeds:
in water (control batch)
in a solution comprising 97.5% water and 2.5% sucrose stearate (treated batch).

The seeds are next dried in a heating tunnel at 45° C. for 1 h.

The seeds are mechanically sown (seeder) on strips of four rows each one beside the other to limit as much as possible the variations in soil quality, insulation and temperature. 12 weeks after sowing, 25 parsley plants were taken in order to measure several parameters of the roots: their weight, their length, and their diameter.

The results are presented in FIG. 5.

12 weeks after sowing, it is found that, in the treated plants:
74% of the roots have a length of more than 10 cm compared with 37% for the control;
the diameter of the taproot of the treated plants is on average 30% greater than the control;
the weight of the taproot of the treated plants is on average 70% greater than the control.

The application of sucrose stearate on the seeds enables better root growth on the field-grown parsley plants.

### Example 6: Effect of a Sugar Ester on the Capacity of the Roots to Absorb Water

The sugar ester used is sucrose stearate.

Parsley plants in pots are grown in a climate-controlled chamber in the following conditions: 23° C. and a photoperiod of 16 h/8 h. A parsley pot comprises between 20 and 25 parsley plants. The treatment of the parsley plants consists of watering the pots with:
700 ml water (control batch)
700 ml of a solution comprising 99.99% and 0.01% sucrose stearate (batch treated with 0.05%)
700 ml of a solution comprising 99.95% and 0.05% sucrose stearate (batch treated with 0.05%)
700 ml of a solution comprising 99.85% and 0.15% sucrose stearate (batch treated with 0.15%)

Two days after watering, the roots are taken, weighed then placed at 42° C. After 30 min, 1 h 30, 2 h, 4 h and 48 h, the weight of the roots is noted and the amount of water retained is calculated as a percentage of the initial weight.

The results are presented in FIG. 6.

The amount of water absorbed increases linearly with the amount of sucrose stearate applied during the treatment (0.05 and 0.15%).

The application of sucrose stearate by watering facilitates the absorption of the water by the roots. This may be explained by the root growth and in particular the modification of the root architecture.

### Example 7: Effect of a Sugar Ester on the Spreading of an Aqueous Solution on a Leaf

The sugar ester used is sucrose stearate.

Strawberry plants in pots are grown in a climate-controlled chamber in the following conditions: 23° C. and a photoperiod of 16 h/8 h.

The application of the invention is made by spraying on the leaves:
water (control batch)
a solution composed of 99.25% water and 0.75% sucrose stearate (treated batch)

The effect of sucrose stearate is observed by the number and the size of the drops on the upper surface of the leaf.

The results are presented in FIG. 7.

With application of sucrose stearate by spraying, the solution is distributed evenly over the leaf, the spreading of the drops being optimized. Furthermore, much greater passage of the solution onto the lower face was observed, compared with the control batch.

When sprayed, the sucrose stearate increases the contact surface area and thus enables phytosanitary treatments to be optimized.

### Example 8: Effect of a Sugar Ester on the Evaporation of Water at the Surface of the Leaves

The sugar ester used is sucrose stearate of which a solution is applied by spraying onto detached leaves of Buddleja davidii disposed flat on a support. The treatment consists of spraying onto the detached leaves:
14 grams of water (control batch)
14 grams of a solution composed of 97% water and 3% sucrose stearate (treated batch).

The leaves are then kept vertical for 6 seconds.

The weight of the leaf is noted prior to the treatment, 1 min after, then every 5 min. The percentage of water retained is calculated relative to the initial weight.

The results are presented in FIG. 8.

The amount of water retained by the treated leaves is 3 to 8 times greater than the water retained by the control leaves.

The application of sucrose stearate by spraying limits the evaporation of an aqueous solution on the leaves and thus increases the contact time. The invention thus has a moistening effect by promoting the maintenance of the moisture level on the surface of the leaf.

### Example 9: Effect of a Sugar Ester on a Calcium Content of the Leaves (Penetration Improvement)

The sugar ester used is sucrose stearate.

Parsley plants in pots are grown in a climate-controlled chamber in the following conditions: 23° C. and a photoperiod of 16 h/8 h.

The application of the invention is made by watering into the containers (180 ml) every three days and spraying onto the leaves twice daily for seven days:
water (control batch)
a solution composed of 97% water and 3% sucrose stearate (treated batch)

After seven days of treatment, the leaves are harvested and analyzed to determine their calcium content.

The results are presented in FIG. 9.

The treatment with the invention enables a reduction of 17% in the level of calcium in the leaves.

The application by spraying and watering of sucrose stearate reduces the amount of foliar calcium, which is key element in the rigidity of the middle lamella, so increasing the permeability of the middle lamella. Therefore, the application of a sugar ester according to the invention enables better penetration of the products applied to the plant.

### Example 10: Effect of a Sugar Ester on the Protein Content of Parsley (Improvement in the Nutrient Efficiency)

The sugar ester used is sucrose stearate.

Parsley plants in pots are grown in a climate-controlled chamber in the following conditions: 23° C. and a photoperiod of 16 h/8 h. The treatment of the parsley plants consists of watering the pots every three days with:
40 ml water (control batch)
40 ml of a solution composed of 99.25% water and 0.75% sucrose stearate (treated batch).

Each batch consists of four pots. After 23 days of treatment the leaves are cut and an analysis of the amount of protein is carried out.

The results are presented in FIG. 10.

The batch treated with sucrose stearate enables an increase of 56% in the protein amount compared with the control batch.

The use of sucrose stearate in the watering water enables greater synthesis of protein, thus showing better nitrogen uptake.

### Example 11: Effect of a Sugar Ester on Root Growth

The sugar ester used is sucrose stearate.

The treatment of the maize seeds consists of immersing them 1 h in a solution comprising water alone (control batch) or in a solution composed of 97.5% water and 2.5% sucrose stearate (treated batch). The seeds are next dried in a heating tunnel at 45° C. for one hour. Four batch repetitions of 16 seeds are deposited on Petri dishes containing a medium composed of 2% Agar Agar and 98% water.

The Petri dishes are kept at ambient temperature and in darkness.

The results are presented in FIG. 11.

After two days, rootlet presence is observed (fuzz around the radicle) on the germinated treated seeds whereas on the control seeds the rootlets are not yet present.

### Example 12: Effect of a Sugar Ester on the Vertical Anchoring of the Root (Assays in Fields)

The sugar ester used is sucrose stearate.

In order to test the effect of the invention in conditions of crops in the field, the flat-leaf parsley variety NOVAS is used.

The treatment consists of immersion for 1 h of the NOVAS parsley seeds:
in water (control batch)
in a solution comprising 97.5% water and 2.5% sucrose stearate (treated batch).

The seeds are next dried in a heating tunnel at 45° C. for 1 h.

The seeds are mechanically sown (seeder) on strips of four rows each one beside the other to limit as much as possible the variations in soil quality, insulation and temperature.

12 weeks after sowing, 25 parsley plants were harvested in order to observe root morphology.

The results are presented in FIG. 12.

The results show that the treatment of the parsley seeds with sucrose stearate leads to root elongation, coupled with vertical anchorage of the roots.

### Example 13: Use of Sorbitan Laurate as a Germination Stimulating Substance for Maize Seeds

Sorbitan laurate (Sub4) was used in comparison with treatment using water alone (control), or with sucrose stearate (treated).

The treatment of the maize seeds consists of immersing them 1 h in a solution comprising water alone (control batch) or in a solution composed of 98.25% water and 0.75% of a polyol derivative non-ionic surfactant (treated batch, Sub4). The seeds are next dried in a heating tunnel at 45° C. for one hour. Two batch repetitions of 16 seeds are deposited on Petri dishes containing a medium composed of 2% Agar Agar and 98% water.

The Petri dishes are kept at ambient temperature and in darkness. Each day the number of seeds that have germinated (having a radicle) is counted.

The results after one day and two days (D1 and D2 respectively) are presented in FIG. 13.

The results show that the treatment of the maize seeds with sorbitan laurate leads to an increase in the germination rate relative to the control, with a germination rate of 31% at D1 and 78% at D2.

### Example 14: Use of Sucrose Palmitate as a Germination Stimulating Substance for Maize Seeds

Sucrose palmitate (Sub1) was used in comparison with treatment using water alone (control), or with sucrose stearate (treated).

The treatment of the maize seeds consists of immersing them 1 h in a solution comprising water alone (control batch) or in a solution composed of 98.25% water and 0.75% of a polyol derivative non-ionic surfactant (treated batch, Sub1). The seeds are next dried in a heating tunnel at 45° C. for one hour. Two batch repetitions of 16 seeds are deposited on Petri dishes containing a medium composed of 2% Agar Agar and 98% water.

The Petri dishes are kept at ambient temperature and in darkness. Each day the number of seeds that have germinated (having a radicle) is counted.

The results after one day and two days (D1 and D2 respectively) are presented in FIG. 14.

The results show that the treatment of the maize seeds with sucrose palmitate leads to an increase in the germination rate relative to the control, with a germination rate of 28% at D1 and 78% at D2.

### Example 15: Use of Glucose Stearate as a Germination Stimulating Substance for Maize Seeds

Glucose stearate (Sub7) was used in comparison with treatment using water alone (control), or with sucrose stearate (treated).

The treatment of the maize seeds consists of immersing them 1 h in a solution comprising water alone (control batch) or in a solution composed of 98.25% water and 0.75% of a polyol derivative non-ionic surfactant (treated batch, Sub7). The seeds are next dried in a heating tunnel at 45° C. for one hour. Two batch repetitions of 16 seeds are deposited on Petri dishes containing a medium composed of 2% Agar Agar and 98% water. The Petri dishes are kept at ambient temperature and in darkness. Each day the number of seeds that have germinated (having a radicle) is counted.

The results after one day and two days (D1 and D2 respectively) are presented in FIG. 15.

The results show that the treatment of the maize seeds with glucose stearate leads to an increase in the germination rate relative to the control, with a germination rate of 34% at D1 and 78% at D2.

### Example 16: Use of Polyethoxylated Sorbitan Laurate as a Germination Stimulating Substance for Maize Seeds

Polyethoxylated sorbitan laurate (Sub4), this also being called polysorbate 20, was used in comparison with treatment using water alone (control), or with sucrose stearate (treated).

The treatment of the maize seeds consists of immersing them 1 h in a solution comprising water alone (control batch) or in a solution composed of 98.25% water and 0.75% of a polyol derivative non-ionic surfactant (treated batch, Sub2). The seeds are next dried in a heating tunnel at 45° C. for one hour. Two batch repetitions of 16 seeds are deposited on Petri dishes containing a medium composed of 2% Agar Agar and 98% water.

The Petri dishes are kept at ambient temperature and in darkness. Each day the number of seeds that have germinated (having a radicle) is counted.

The results after one day and two days (D1 and D2 respectively) are presented in FIG. 16.

The results show that the treatment of the maize seeds with polyethoxylated sorbitan laurate (polysorbate 20) leads to an increase in the germination rate relative to the control, with a germination rate of 25% at D1 and 78% at D2.

### Example 17: Use of Decyl Glucoside as a Germination Stimulating Substance for Maize Seeds

Decyl glucoside (Sub3) was used in comparison with treatment using water alone (control), or with sucrose stearate (treated).

The treatment of the maize seeds consists of immersing them 1 h in a solution comprising water alone (control batch) or in a solution composed of 98.25% water and 0.75% of a polyol derivative non-ionic surfactant (treated batch, Sub3). The seeds are next dried in a heating tunnel at 45° C. for one hour. Two batch repetitions of 16 seeds are deposited on Petri dishes containing a medium composed of 2% Agar Agar and 98% water.

The results after one day and two days (D1 and D2 respectively) are presented in FIG. 17.

The results show that the treatment of the maize seeds with decyl glucoside leads to an increase in the germination rate relative to the control, with a germination rate of 19% at D1 and 84% at D2.

### Example 18: Use of N-Lauroyl-N-Methyl Glucamide as a Germination Stimulating Substance for Maize Seeds

N-lauroyl-N-methyl glucamide (Sub6) was used in comparison with treatment using water alone (control), or with sucrose stearate (treated).

The treatment of the maize seeds consists of immersing them 1 h in a solution comprising water alone (control batch) or in a solution composed of 98.25% water and 0.75% of a polyol derivative non-ionic surfactant (treated batch, Sub6). The seeds are next dried in a heating tunnel at 45° C. for one hour. Two batch repetitions of 16 seeds are deposited on Petri dishes containing a medium composed of 2% Agar Agar and 98% water.

The results after one day and two days (D1 and D2 respectively) are presented in FIG. 18.

The results show that the treatment of the maize seeds with N-lauroyl-N-methyl glucamide leads to an increase in the germination rate relative to the control, with a germination rate of 28% at D1 and 65% at D2.

### Example 19: Use of Methylglucose Dioleate as a Germination Stimulating Substance for Maize Seeds

Methylglucose dioleate (Sub5) was used in comparison with treatment using water alone (control), or with sucrose stearate (treated).

The treatment of the maize seeds consists of immersing them 1 h in a solution comprising water alone (control batch) or in a solution composed of 98.25% water and 0.75% of a polyol derivative non-ionic surfactant (treated batch, Sub5). The seeds are next dried in a heating tunnel at 45° C. for one hour. Two batch repetitions of 16 seeds are deposited on Petri dishes containing a medium composed of 2% Agar Agar and 98% water.

The Petri dishes are kept at ambient temperature and in darkness. Each day the number of seeds that have germinated (having a radicle) is counted.

The results after one day and two days (D1 and D2 respectively) are presented in FIG. 19.

The results show that the treatment of the maize seeds with methylglucose dioleate leads to an increase in the germination rate relative to the control, with a germination rate of 18% at D1 and 65% at D2.

### Example 20: Improvement in Yield (Barley)

The sugar ester used is sucrose stearate.

Assays in a climate controlled chamber (temperature 22° C./20° C., photoperiod 16 h/8 h, 25,000 lux) were carried out on winter barley (Sobell variety, Arvalis). The barley was sowed in containers of 1 meter by 1 meter. At the commencement of tillering, the barley was treated by spraying with:
Control batch: 3 I/ha water
Treated batch: 3 I/ha of a solution composed of 97% water and 3% sucrose stearate.

The plants were then watered every 2 weeks with the same amount of water for both control batch and treated batch.

The yields were then calculated as the ratio of the weight of harvested seeds to the sowed area. This ratio is expressed in q/ha. The results are presented in Table 2 below:

TABLE 2

| | Control batch | Trated batch |
|---|---|---|
| Yield (q/ha) | 54.2 | 67.9 |

The use of sugar ester according to the invention enables the yield to be increased by 25%.

### Example 21: Effect of a Sugar Ester on Penetration of the Mixture

The sugar ester used is sucrose stearate.

Rape, a plant known for having a thick cuticle, was chosen in order to test the effectiveness of the invention as a penetrating agent.

A colorant in aqueous solution was deposited on a rape leaf, then left for 2 h and then wiped. Two solutions were tested:
Control: water alone
Treated: a solution comprising 97.5% water and 2.5% sucrose stearate.

Photographs were taken at each step and are presented in FIG. 20.

The results show that the use of sugar ester according to the invention enables the colorant to color the leaf and thus to penetrate through the cuticle. Water alone did not enable the colorant to cross the physical barrier represented by the rape cuticle.

The use of sugar ester according to the invention makes it possible to increase the capacity of an aqueous solution to penetrate the cuticle, thus showing that it can be used as a penetration agent.

### Example 22: Effect of a Sugar Ester on Drift Limitation

The sugar ester used is sucrose stearate.

To measure the effect of the sugar ester according to the invention on the formation of drops after spraying, two solutions were sprayed with a nozzle of conventional slot type:
a solution composed of 95% water and 5% titanium dioxide (control batch)
a solution composed of 92.5% water, 5% titanium dioxide and 2.5% sucrose stearate (treated batch).

Increasing pressures (2, 4 and 8 bars) were used in order to test different conditions (FIG. 21: a, b and c respectively). The greater the pressure the more numerous and fine were the drops.

It is found that, under the 3 conditions tested, the use of sugar ester according to the invention enables an increase the size of the drops. The use sugar ester according to the invention thus makes it possible limit drift by promoting the increase in the size of the drops or droplets.

### Example 23: Effect of a Sugar Ester on the Stickiness of a Solution on the Leaf

The sugar ester used is sucrose stearate.

A solution is applied by spraying on detached leaves of Buddleja davidii disposed flat on a support. The treatment consists of spraying onto the detached leaves:
14 grams of a solution composed of 97% water and 3% titanium dioxide (control batch)
14 grams of a solution composed of 94.5% water, 3% titanium dioxide and 2.5% sucrose stearate (treated batch).

The leaves were next left at ambient temperature until the sprayed solutions had completely evaporated.

14 grams of water are next sprayed onto the leaves held vertical to simulate rain. The titanium residues on the leaf are next observed.

The results are presented in FIG. 22.

In the control batch, the titanium dioxide is practically imperceptible after washing. In contrast, in the treated batch the titanium dioxide is still clearly visible, even though slight reduction in the coloration after washing may be observed.

The results show that the use of the sugar ester according to the invention makes it possible to limit the washing off of phytosanitary products.

### Example 24: Effect of a Sugar Ester on the Formation of Foam on Preparing the Mixture

The sugar ester used is sucrose stearate.

In order to measure the effect of the use of a sugar ester according to the invention on the formation of foam when mixing, two solutions were prepared:
control batch: a solution composed of 99% water and 1% foaming agent (Cocamidopropyl betaine).
treated batch: a solution composed of 98% water and 1% foaming agent (Cocamidopropyl betaine) and 1% sucrose stearate.

The two solutions were next stirred in equivalent manner, the photographs being taken before, immediately after stirring and 1 h after stirring. The results are presented in FIG. 23.

The results show that the use of a sugar ester according to the invention makes it possible to reduce the volume of foam obtained immediately after stirring by 30%. The invention makes it possible to mitigate the formation of foam on preparing phytosanitary mixtures.

### Example 25: Effect of a Sugar Ester on Homogenization of the Mixture

The sugar ester used is sucrose stearate.

In order to test the effect of the use of a sugar ester according to the invention on the homogenization of the mixture, a mixture of two solutions of identical (aqueous) solubility but of different densities (1 and 1.7 g/cm³) was carried out. Two assays were carried out:
Control: solution composed of 98% water and 2% glycerin colored blue
Treated: solution composed of 97% water, 1% sucrose stearate and 2% glycerin colored blue.

The mixtures were next stirred in equivalent manner. Photographs are taken after stirring.

The results are presented in FIG. 24.

The use of a sugar ester according to the invention enables better homogenization of the mixture.

### Example 26: Effect of a Sugar Ester on pH Modification of the Mixture

The sugar ester used is sucrose stearate.

In order to measure the effect of the use of a sugar ester according to the invention on pH, a solution at pH 9.4 was prepared, and a solution composed of 97.5% water and 2.5% sucrose stearate was also prepared.

The solution comprising sucrose stearate (solution according to the invention) was added to the solution at pH 9.4 at different concentrations: 0.1%, 0.5%, 1%, 2%, 3%, 5% et 10%. The pH was measured after each addition of the invention.

The results are presented in FIG. 25.

It was possible to measure that as of addition of 0.5% of the solution comprising sucrose stearate, the pH drops from 9.4 to 6.33. By increasing the concentration of the solution comprising sucrose stearate, the pH then stabilizes at 5.25.

The use of a sugar ester according to the invention thus enables acidification of the mixture as of 0.5%.

### Example 27: Effect of a Sugar Ester on Solubilization of the Mixture

The sugar ester used is sucrose stearate.

Two mixtures were prepared:
control batch: mixture comprising 95% water and 5% sunflower oil
treated batch: mixture comprising 5% sunflower oil and 95% of a solution composed of 97.5% water and 2.5% sucrose stearate.

The two mixtures were made at ambient temperature with fast stirring.

The stability of the mixtures is noted in two ways:
After passage through an oven (45° C.) for 24 h,
After centrifugation for 20 min at 4000 rpm (revolutions per minute).

The results are presented in FIG. 26.

In the two tests carried out it is observed that the control batch presents two phases whereas the treated batch presents only one phase, including after centrifugation.

The use of a sugar ester according to the invention thus makes it possible to increase the solubilization of a substance that is immiscible with the mixture.

### Example 28: Effect of a Sugar Ester on Persistence of the Mixture at the Foliar Surface

The sugar ester used is sucrose stearate.

The effect of the invention on the persistence of the mixture was evaluated after spraying a solution colored blue on detached leaves of Buddleja davidii.

Two assays were carried out:
Control: solution composed of 99.9% water and 0.1% colorant
Treated: solution composed of 98.9% water, 0.1% colorant and 1% sucrose stearate.

After spraying, the leaves are left at ambient temperature until the sprayed solution has evaporated.

Next, several operations of rinsing the leaves with water are carried out. The rinse water is collected after each rinse and photographs are taken to observe and compare the coloration of the rinse waters. An absorbance measurement at 630 nm is also carried out by spectrophotometry.

The results are presented in FIG. 27.

The results show that, on the control batch the persistence of the mixture disappears at the 2^{nd} rinse, whereas on the treated batch the mixture is still present even after the 4^{th} rinse.

The absorbance measurements confirm the observations made above (FIG. 28). On the control batch, the washing off of the product at the surface is very great; this is observed on the value of the optical density (OD) which is much higher in the treated batch. This is confirmed by the measurement made on the other 3 rinses for which the OD of the control is low (less product present on the surface of the leaf) while product remains on the control batch.

The use of a sugar ester according to the invention thus enables better persistence of the mixture on the foliar surface.

### Example 29: Impact of a Sugar Ester on Microorganisms (Biocompatibility)

The sugar ester used is sucrose stearate.

In order to evaluate any impact of the sugar esters used according to the invention on microorganisms, the fungicide effect was searched for by an antibiogram type method.

The method consists of:
spreading a solution contaminated with the mold Aspergillus niger on the surface of a Petri dish containing glucose gel growth medium with chloramphenicol.
arrange 4 sterile antibiogram disks of 6 mm diameter per Petri dish.
inoculate with 3 drops (0.071 g) of solution to test or control solution per disk.

The dishes are next placed in the incubator at 25° C. for 5 days.

Measurement of the inhibitory diameter is carried out every day.

The solutions tested are:
Treated 0.1%: a solution composed of 99.9% water and 0.1% sucrose stearate
Treated 1%: a solution composed of 99% water and 1% sucrose stearate
Treated 3%: a solution composed of 97% water and 3% sucrose stearate
Treated 10%: a solution composed of 90% water and 10% sucrose stearate
Control: an agricultural fungicide (Epoxiconazole)

The results are presented in Table 3.

TABLE 3

| | Inhibitory diameter in mm | | | | |
|---|---|---|---|---|---|
| Sample | D1 | D2 | D3 | D4 | D5 |
| TREATED | 0 | 0 | 0 | 0 | 0 |
| 0.1% | | | | | |
| TREATED | 0 | 0 | 0 | 0 | 0 |
| 1% | | | | | |
| TREATED | 0 | 0 | 0 | 0 | 0 |
| 3% | | | | | |
| TREATED | 0 | 0 | 0 | 0 | 0 |
| 10% | | | | | |
| CONTROL | 0 | 32 | 30 | 30 | 29 |

The results show that, compared with a fungicide product used as a positive control, sugar ester presents no fungicide effect whatever the concentrations tested.

### Example 30: Solubility of a Sugar Ester

The sugar ester used is sucrose stearate.

To define the solubility of a sugar ester according to the invention, 3% sucrose stearate was mixed with water (Batch A) or with sunflower oil (Batch B). After mixing, the two solutions were centrifuged 5 min at 4000 rpm. A photograph was taken after centrifugation and is presented in FIG. 29.

After centrifugation, only one phase is still observed, whether it be mixed with water or with oil, showing the stability of the solution.

The results show that the sugar ester according to the invention is miscible with water and also with oil.

### Example 31: Effect of a Sugar Ester on the Reduction of Phytosanitary Products on Wheat

The sugar ester used is sucrose stearate.

Assays in a climate-controlled chamber were carried out on soft winter wheat (GARCIA variety, Arvalis). The wheat was sowed in containers of 1 meter by 1 meter. At the last leaf spread stage the wheat was treated with two fungicides commercialized under the names Priaxor® and Reimer® Pro. Priaxor® comprises two active ingredients: fluxapyroxad (belonging to the SDHI family) and pyraclostrobin (belonging to the strobilurin family) and Reimer® Pro comprises the active ingredient metconazole (belonging to the triazole family). Two assays were carried out:
Control: 100% of the recommended dose for use, that is to say 0.6 L/ha Priaxor®+0.6 L/ha of Reimer® Pro.
Treated: 25% of the recommended dose for use, that is to say 0.15 L/ha de Priaxor®+0.15 L/ha of Reimer® Pro, in addition to 3 L/ha sucrose stearate.

The containers were then taken out of the climate-controlled chamber and disposed near a field having more than 50% of wheat plants diseased with Septoria leaf spot. After 1 day, the containers were placed back in the climate-controlled chamber under controlled conditions.

The photographs are taken at the start of coming into ear and are presented in FIG. 30.

It is found that the number of diseased plants is substantially greater in the control batch compared with the treated batch, with 80% of the plants diseased with Septoria leaf spot for the control as compared with 20% for the treated batch, this being the case despite a reduction in 25% of phytosanitary products.

The use of a sugar ester according to the invention thus makes it possible to obtain greater effectiveness with lower concentrations of phytosanitary products. This function according to the invention thus enables the farmer to reduce the amount of phytosanitary products used in terms of concentration and/or frequency.

### Example 32: Effect of a Sugar Ester on the Reduction of Phytosanitary Products on Maize

The sugar ester used is sucrose stearate.

Assays in a climate-controlled chamber were carried out on maize (P7043, Pioneer). The maize was sowed in containers of 1 meter by 1 meter. At the stage of 8-10 leaves, the maize plants were treated with two fungicides commercialized under the names Amistar® and Cicero®. Amistar® comprises the active ingredient: azoxystrobin (belonging to the strobilurin family), and Cicero® comprises two active ingredients: chlorothalonil (belonging to the chloronitrile family), and flutriafol (belonging to the triazole family). Two assays were carried out:
Control: 100% of the recommended dose for use, that is to say 1 L/ha Amistar®+2.5 I/ha of Cicero®
Treated: 25% of the recommended dose for use, that is to say 0.25 L/ha de Amistar®+0.6 L/ha of Cicero®, in addition to 3 L/ha sucrose stearate.

The containers were then taken out of the climate-controlled chamber and disposed near a field having more than 50% of maize plants diseased with Helminthosphaeria. After 1 day, the containers were placed back in the climate-controlled chamber under controlled conditions.

The photographs of control and treated batches were taken at the 12-14 leaf stage and are presented in FIG. 31.

It is found in the control batch that 70% of the plants presented Helminthosphaeria spots, whereas for the treated batch less than 10% presented Helminthosphaeria spots, this being the case despite a reduction in 25% of phytosanitary products.

The use of a sugar ester according to the invention thus makes it possible to obtain greater effectiveness with lower concentrations of phytosanitary products. This function according to the invention thus enables the farmer to reduce the amount of phytosanitary products used in terms of concentration and/or frequency.

1. A plant growth stimulating agent comprising at least one polyol derivative non-ionic surfactant having activity on the seeds and/or the roots of a plant, said polyol derivative being a sugar derivative.

2. The plant growth stimulating agent according to claim 1, characterized in that said polyol derivative non-ionic surfactant stimulates or promotes the germination, the root growth, and/or the vertical anchoring of the roots of a plant.

3. The plant growth stimulating agent according to claim 1, wherein said polyol derivative non-ionic surfactant improves nutrient efficiency and/or the yield of seed or fruit plants.

4. An adjuvant for a phytosanitary product comprising at least one polyol derivative non-ionic surfactant, said polyol derivative being a sugar derivative.

5. The adjuvant for a phytosanitary product according to claim 4, wherein the adjuvant for a phytosanitary product makes it possible to promote the absorption of water and/or the retention of water in the leaves, the roots and/or the integuments; the spreading on the surface of plants, both aerial and underground parts, in order to increase the contact surface area; the penetration of molecules by the middle lamella and/or the contact time with the active or nutritive substances, and/or the limitation of the evaporation of water by the leaves.

6. The adjuvant for a phytosanitary product according to claim 4, wherein said polyol derivative non-ionic surfactant is used as a:
penetration agent, and/or
drift-limiting agent, and/or
stickiness agent, and/or
defoaming agent, and/or
solubilizing agent, and/or
pH modifying agent, and/or
homogenizing agent, and/or
foliar surface persistence agent, and/or
agent enabling the content of phytosanitary product to be reduced.

7. The adjuvant for a phytosanitary product according to claim 4, wherein said polyol derivative non-ionic surfactant is biocompatible with microorganisms.

8. The plant growth stimulating agent according to claim 1, wherein the polyol derivative non-ionic surfactant is chosen from esters of sugar and fatty acid(s), alkylmonoglucosides, alkylpolyglucosides, esters of alkylmonoglucoside and fatty acid(s), esters of alkylpolyglucoside and fatty acid(s) and N-alkylglucamides.

9. The plant growth stimulating agent according to claim 1, wherein the polyol derivative non-ionic surfactant is chosen from sucrose esters, sorbitan esters, and glucose esters.

10. The plant growth stimulating agent according to claim 1, wherein the polyol derivative non-ionic surfactant is ethoxylated or is not ethoxylated.

11. The plant growth stimulating agent according to claim 1, wherein the polyol derivative non-ionic surfactant is chosen from sucrose stearate, sucrose palmitate, glucose stearate, sorbitan laurate, polyethoxylated sorbitan laurate, decylglucoside, N-lauroyl-N-methylglucamide and dioleate methylglucose.

12. The plant growth stimulating agent according to claim 1, wherein the polyol derivative non-ionic surfactant is sucrose stearate.

13. The plant growth stimulating agent according to claim 1, wherein the polyol derivative non-ionic surfactant is used in a composition in the form of a single-phase solution, or an emulsion.

14. The plant growth stimulating agent according to claim 13, wherein said polyol derivative non-ionic surfactant is used in a composition in the form of an aqueous single-phase solution.

15. The plant growth stimulating agent according to claim 13, wherein the polyol derivative non-ionic surfactant is used in a range from approximately 0.01% to approximately 80% by weight of polyol derivative non-ionic surfactant relative to the total weight of the composition.

16. The plant growth stimulating agent according to claim 13, wherein the polyol derivative non-ionic surfactant is used in a range from approximately 0.05% to approximately 30% by weight of polyol derivative non-ionic surfactant relative to the total weight of the composition.

17. A method for stimulating plant growth comprising applying an effective amount of the plant growth stimulating agent according to claim 1 in pre or post emergence, on the seed, the roots, the seedling, the plant, the fruit, the flowers, the leaves, the stems, and/or in the soil, and/or the growth medium, before or after sowing.

18. The method according to claim 17 wherein the plant being chosen from Dicotyledons and Monocotyledons and more particularly from the group comprising cereals and cereal products, plants with roots and tubers, sacchariferous plants, legumes, nut-bearing plants, oleiferous and oleaginous plants, vegetable crop plants, fruit crop plants, aromatic and spice plants, flower crop plants, and industrial crop plants for the production of a raw material for its transformation.

19. A method of stimulating the germination and/or the root growth and/or the vertical anchoring of the roots of a plant, comprising applying at least one sugar derivative non-ionic surfactant as described in claim 8.

20. The method according to claim 19, wherein the applying step is carried out after emergence or before emergence.

21. The method according to claim 19, wherein the applying step is carried out by spraying, watering the plant, adding to a growth medium in hydroponics, immersing the seed and/or coating the seed.
